(19) United States
(12) Patent Application Publication
(10) Pub. No.: US 2011/0029481 A1
(43) Pub. Date: Feb. 3, 2011

(54) CONTROL SYSTEM AND METHOD FOR DATA STORAGE

(75) Inventors: YANG-YUAN CHEN, Tu-Cheng (TW); MING-CHIH HSIEH, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/546,696

(22) Filed: Aug. 25, 2009

(30) Foreign Application Priority Data
Jul. 30, 2009 (CN) 200910305012.4

(51) Int. Cl. G06F 17/30

(52) U.S. Cl. 707/617; 707/E17.001

(57) ABSTRACT

A control system for data storage can prevent data loss while a connection between an electronic device and a storage device is disconnected. When the connection between the electronic device and the storage device is disconnected, data is stored in a backup device. When the connection between the electronic device and the storage device is reconnected, data stored in the backup device is transferred to the storage device to prevent data loss during the connection between the electronic device and the storage device was disconnected.

### BACKGROUND

1. Technical Field

The present disclosure relates to control systems and methods for data storage, and particularly to a control system connected to a storage device and a control method for data storage utilizing the control system.

2. Description of Related Art

Common digital electronic devices, such as video recorders, are widely used. An existing video recorder can store image/video data, sound data or other kinds of data in a storage device, such as a server which is connected to the video recorder via a network connector. However, if the connection/communication between the device and the server is disconnected while data is being transferred to the server, the data saving process will be suddenly interrupted, and as a result, lead to data loss.

### BRIEF DESCRIPTION OF THE DRAWINGS

FIG. 1 is a block diagram of an exemplary embodiment of a control system for data storage, the control system including a secure digital card.

FIG. 2 is a schematic diagram of the secure digital card of FIG. 1.

FIG. 3 is a flowchart of an exemplary embodiment of a control method for data storage.

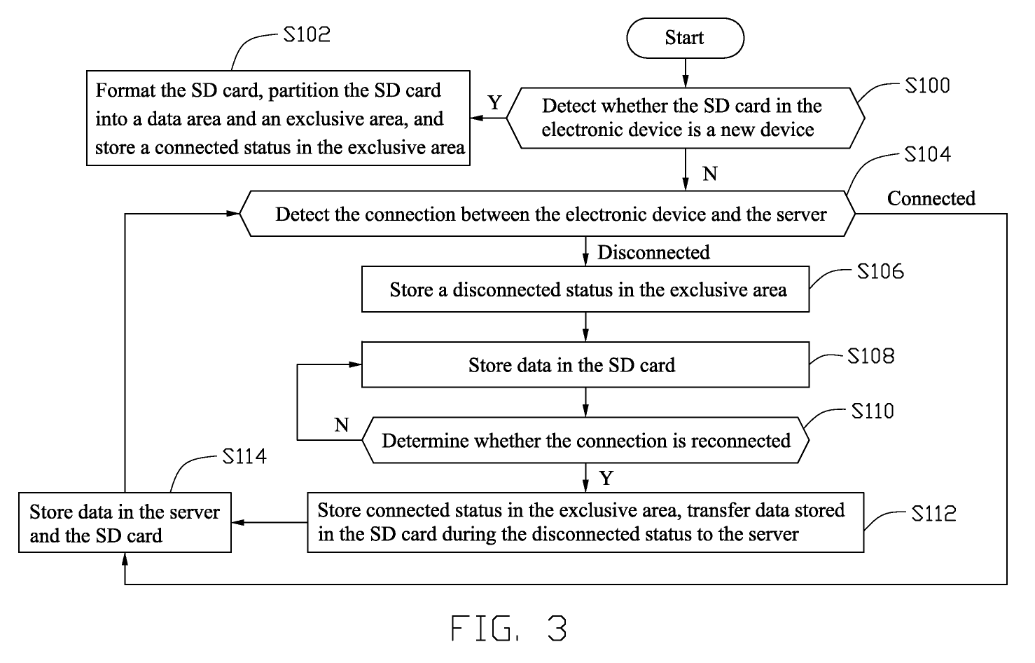

### DETAILED DESCRIPTION

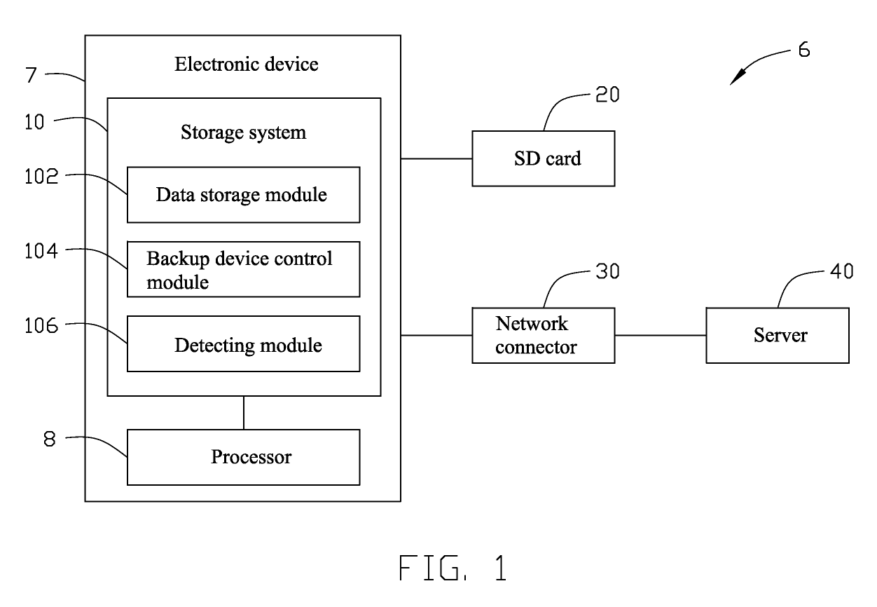

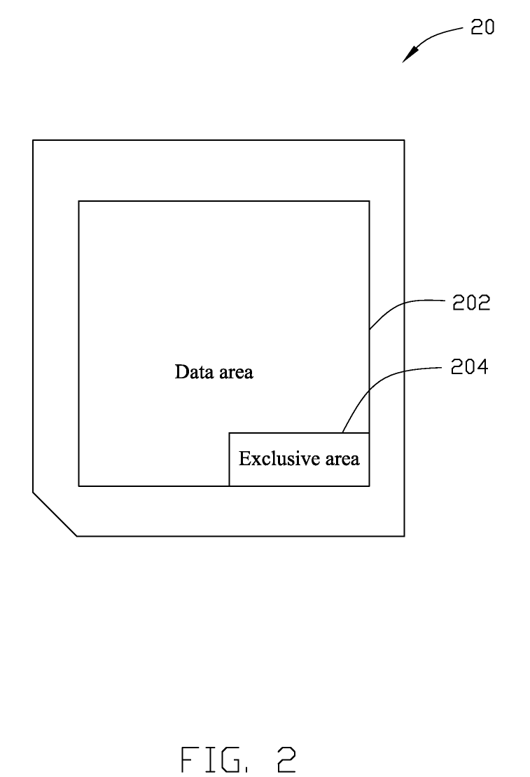

Referring to FIGS. 1 and 2, an exemplary embodiment of a control system 6, which can prevent data loss while a connection/communication between the control system 6 and a remote storage device, such as a server 40, becomes disconnected is shown. The control system 6 includes an electronic device 7, a backup device, such as a secure digital (SD) card 20, and a network connector 30. The electronic device 7 is connected to the SD card 20, and connected to the server 40 via the network connector 30. In one embodiment, the electronic device 7 may be a video recorder or other types of electronic device, and the network connector 30 may be a router, a hub, or other types of network device.

The electronic device 7 includes a processor 8 and a storage system 10. The processor 8 is connected to the storage system 10 that stores a number of modules each of which contains one or more computerized instructions to be executed by the processor 8. The number of modules includes a data storage module 102, a backup device control module 104, and a detecting module 106.

The data storage module 102 stores data, such as image or sound data, generated by the electronic device 7 to the server 40 and the SD card 20.

The backup device control module 104 detects whether the SD card 20 in the electronic device 7 is a new device. If the SD card 20 in the electronic device 7 is a new device, the backup device control module 104 formats the SD card 20 and partitions the SD card 20 into a data area 202 and an exclusive area 204 that stores a connection/communication status between the electronic device 7 and the server 40, such as connected/disconnected or up/down, and stores a connected status in the exclusive area 204 by default. If the SD card 20 in the electronic device 7 is not a new device, the SD card 20 is not formatted. In one embodiment, the backup device control module 104 searches for the exclusive area 204 in the SD card 20 to determine whether the SD card 20 is a new device. If the exclusive area 204 is found in the SD card 20, the SD card 20 is not a new device. If the exclusive area 204 is not found in the SD card 20, the SD card 20 is determined to be a new device.

The detecting module 106 periodically detects the connection/communication between the electronic device 7 and the server 40. If the connection is disconnected, the detecting module 106 stores a disconnected status in the exclusive area 204, and only stores data in the SD card 20. Otherwise, data is stored in the server 40 and the SD card 20. In one embodiment, the detecting module 106 detects the connection by pinging the server 40. The detecting module 106 further detects whether the connection between the electronic device 7 and the server 40 is reconnected. If the connection between the electronic device 7 and the server 40 is reconnected, the detecting module 106 stores a connected status in the exclusive area 204, and transfers data stored in the SD card 20 during the disconnected status to the server 40 to prevent data loss, and data is stored in the server 40 and the SD card 20 after finishing transferring data from the SD card 20 to the server 40. If the connection between the electronic device 7 and the server 40 is not reconnected, data keeps being stored in the SD card 20. In other embodiments, the detecting module 106 can also obtain the connection status between the electronic device 7 and the server 40 by searching for the exclusive area 204.

FIG. 2 is an exemplary embodiment of a control method applied in the above mentioned control system 6 to prevent data loss. The control method includes the following steps.

In step S100, the backup device control module 104 detects whether the SD card 20 in the electronic device 7 is a new device. If the SD card 20 in the electronic device 7 is a new device, the procedure goes to step S102. If the SD card 20 in the electronic device 7 is not a new device, the procedure goes to step S104.

In step S102, the backup device control module 104 formats the SD card 20, partitions the SD card 20 into a data area 202 and an exclusive area 204, and stores a connected status in the exclusive area 204.

In step S104, the detecting module 106 detects the connection between the electronic device 7 and the server 40. If the connection is disconnected, the procedure goes to step S106. Otherwise, the procedure goes to step S114.

In step S106, the detecting module 106 stores a disconnected status in the exclusive area 204.

In step S108, the detecting module 106 stores data in the SD card 20.

In step S110, the detecting module 106 determines whether the connection between the electronic device 7 and the server 40 is reconnected. If the connection between the electronic device 7 and the server 40 is reconnected, the procedure goes to step S112. If the connection between the electronic device 7 and the server 40 is not reconnected, the procedure returns to step S108.

In step S112, the detecting module 106 stores a connected status in the exclusive area 204, and transfers data stored in the SD card 20 during the disconnected status to the server 40 to prevent data loss.

In step S114, the data storage module 102 stores data generated by the electronic device 7 in the server 40 and the SD card 20, and the procedure goes to step S104.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A control system for data storage, the control system comprising:
a backup device;
a network connector;
a storage device; and
an electronic device connected to the backup device and the storage device via the network connector, and the electronic device comprising a processor and a storage system connected to the processor and storing a plurality of modules each of which contains one or more computerized instructions to be executed by the processor, wherein the plurality of modules comprise:
a data storage module to store data generated by the electronic device in the storage device and the backup device; and
a detecting module to detect a status of connection between the electronic device and the storage device, the detecting module only storing data in the backup device in response to the connection between the electronic device and the storage device being disconnected, the detecting module also determining whether the connection between the electronic device and the storage device is reconnected, and transferring data stored in the backup device to the storage device during the connection between the electronic device and the storage device was disconnected.

2. The system of claim 1, wherein the storage system further comprises a backup device control module, the backup device control module is to detect whether the backup device in the electronic device is a new device, the backup device control module formats the backup device, partitions the backup device into a data area and an exclusive area, and stores a connected status in the exclusive area in response to the backup device in the electronic device being a new device, the backup device is not formatted in response to the backup device in the electronic device being not a new device.

3. The system of claim 1, wherein the backup device control module searches for the exclusive area in the backup device to determine whether the backup device in the electronic device is a new device, the backup device in the electronic device is a new device in response to the exclusive area being found in the backup device, the backup device in the electronic device is not a new device in response to the exclusive area being not found in the backup device.

4. The system of claim 1, wherein the detecting module detects the connection between the electronic device and the storage device by pinging the storage device.

5. The system of claim 1, wherein the backup device is a secure digital card, and the storage device is a server.

6. The system of claim 1, wherein the electronic device is a video recorder, and the network connector is a hub.

7. A control method for data storage, the method comprising:
detecting a status of a connection between an electronic device and a storage device, storing data generated by the electronic device in a backup device in response to the connection between an electronic device and a storage device being disconnected, while storing data in the storage device and the backup device in response to the connection between an electronic device and a storage device being connected; and
determining whether the connection between an electronic device and a storage device is reconnected, transferring data stored in the backup device to the storage device during the connection between an electronic device and a storage device was disconnected, and storing data in the storage device and the backup device after finishing transferring data from the backup device to the storage device in response to the connection between an electronic device and a storage device being reconnected, and returning to the step of detecting a status of a connection between an electronic device and a storage device.

8. The method of claim 7, further comprising:
detecting whether the backup device in the electronic device is a new device, formatting the backup device and partitioning the backup device into a data area and an exclusive area, and storing a connection status in the exclusive area in response to the backup device in the electronic device being a new device.

9. The method of claim 8, further comprising:
detecting whether the backup device in the electronic device is a new device, formatting the backup device and partitioning the backup device into a data area and an exclusive area, and storing a disconnected status in the exclusive area in response to the connection between the electronic device and the storage device being disconnected.

10. The method of claim 9, further comprising:
storing a connected status in the exclusive area in response to the connection between the electronic device and the storage device being reconnected.

11. The method of claim 7, wherein the backup device is a secure digital card, and the storage device is a server.

12. The method of claim 7, wherein the electronic device is a video recorder, and the network connector is a hub.
